(19) United States
(12) Patent Application Publication
(10) Pub. No.: US 2026/0238262 A1
(43) Pub. Date: Aug. 13, 2026

(54) METHODS, APPARATUSES AND SYSTEMS FOR INTELLIGENT REFLECTION SURFACE INSTALLED USER EQUIPMENT CHANNEL ESTIMATION

(71) Applicant: Kyocera Corporation, Kyoto (JP)

(72) Inventors: Amit KALHAN, San Diego, CA (US); Ramon KHALONA, San Diego, CA (US)

(21) Appl. No.: 19/475,164

(22) PCT Filed: Apr. 26, 2024
(86) PCT No.: PCT/US2024/026625

§ 371 Date: Oct. 14, 2025

Related U.S. Application Data
(60) Provisional application No. 63/463,365, filed on May 2, 2023.

(51) Int. Cl. H04B 7/04; H04L 25/02; H04L 27/26

(52) U.S. Cl. CPC H04B 7/04013; H04L 25/0202; H04L 27/26025

(57) ABSTRACT

Methods, apparatuses and systems for intelligent reflection surface (IRS) installed user equipment (UE) channel estimation. In one embodiment, a wireless communication device includes: a transceiver configured to: transmit a first signal to a wireless communication node, wherein the first signal comprises a capability message, wherein the capability message comprises in indication to indicate: a first number of a plurality of reconfigurable elements in an Intelligent Reflecting Surface (IRS) coupled to the wireless communication device, and a second number of at least one antenna that can be supported by the IRS, wherein each of the at least one antenna comprises at least one of the plurality of reconfigurable elements; and receive a second signal from the wireless communication node, wherein the second signal comprises a configuration message, wherein the configuration message comprises a plurality of parameters to be configured in the IRS.

### TECHNICAL FIELD

The disclosure relates generally to wireless communications and, more particularly, to methods, apparatuses and systems for intelligent reflection surface (IRS) installed user equipment (UE) channel estimation.

### BACKGROUND

An IRS is a planar surface comprising a plurality of small, reconfigurable reflecting elements, each of which can induce a controllable amplitude, phase and/or polarization change to the incident signal independently, without need of baseband processing. IRSs are designed to reflect, refract, or scatter incoming electromagnetic waves in a way that optimizes signal strength, minimizes interference, and enhances overall wireless communication performance.

On the other hand, in a wireless communication system, signals are transmitted through wireless channels established between transmitters and receivers. These channels introduce various impairments and distortions to the transmitted signals due to factors such as fading, interference, and noise. Channel estimation in wireless communication is a process used to estimate the characteristics of the communication channel through which signals are transmitted. The general method of channel estimation used in 3GPP 5G NR consists of Base Stations (gNBs) sending Reference Signals (RSs) such as Channel State Information Reference Signals (CSI-RS) so that the terminals such as User Equipment (UEs) can perform channel measurements and compute Channel State Information (CSI) parameters such as Precoding Matrix Indicator (PMI), Rank Indicator (RI), and Channel Quality Index (CQI), and then the UEs sends a CSI report comprising the results of CSI computation to the gNBs.

One drawback of the RS-based channel estimation method is that it takes a finite, and in some cases a relatively considerable amount of time for UEs to perform this computation, which contributes to the phenomenon of so-called “channel aging”. That is, in situations when the channel changes rapidly when UEs move at medium or high speeds, by the time the CSI report is received at the gNB, the UE is already experiencing different channel conditions. One way of dealing with this problem is to predict the channel variations based on several previous CSI measurements. This solution suffers from two problems: first, the delay in computing CSI is not eliminated since it takes a finite amount of time to accumulate enough CSI-RS measurements and to compute the prediction. Second, this method increases the complexity of the UE. Therefore, there is a need to develop new methods and systems for improving the efficiency and accuracy in RS-based UE channel estimation.

### SUMMARY

The exemplary embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

In some embodiments, a method includes: transmitting, at a wireless communication device, a first signal to a wireless communication node, wherein the first signal includes a capability message, wherein the capability message includes in indication to indicate: a first number of a plurality of reconfigurable elements in an Intelligent Reflecting Surface (IRS) coupled to the wireless communication device, and a second number of at least one antenna that can be supported by the IRS, wherein each of the at least one antenna comprises at least one of the plurality of reconfigurable elements; and receiving, at the wireless communication device, a second signal from the wireless communication node, wherein the second signal includes a configuration message, wherein the configuration message includes a plurality of parameters to be configured in the IRS.

In some embodiments, the method further includes: receiving, at the wireless communication device, one or more third signals from the wireless communication node, wherein the one or more third signals includes one or more reference signals transmitted by the wireless communication node; and reflecting, at the wireless communication device, each of the one or more third signals to generate a respective one of one or more fourth signals using the IRS based on the configuration message in the second signal, wherein the one or more fourth signals are used to perform a channel estimation between the wireless communication device and the wireless communication node. In some embodiments, the method further includes: configuring, at the wireless communication device, the IRS based on the plurality of parameters in the configuration message.

In some embodiments, the plurality of parameters includes at least one of: a third number of required antennas in the IRS, wherein the third number is less than or equal to the second number; a symbol separation; a pattern repetition; a subcarrier frequency spacing; and a symbol periodicity.

In some embodiments, the configuration message further includes an indication to indicate whether the IRS operates as a single beam reflector, wherein a respective phase shift of each of the plurality of reconfigurable elements is adjusted such that reflections generated by the IRS are focused to one first beam, or the IRS operates as a multiple-antenna beam reflector, wherein the third number is greater than 1, and each of the third number of required antennas is configured to generate a respective second beam. In some embodiments, the respective second beam associated with each of the third number of required antennas is wider than the first beam.

In some embodiments, each of the at least one antenna is separated from adjacent antennas by a respective distance, wherein the respective distance is determined by a wavelength of signals transmitted between the IRS and the wireless communication node.

### BRIEF DESCRIPTION OF THE DRAWINGS

Various exemplary embodiments of the present disclosure are described in detail below with reference to the following Figures. The drawings are provided for purposes of illustration only and merely depict exemplary embodiments of the present disclosure to facilitate the reader's understanding of the present disclosure. Therefore, the drawings should not be considered limiting of the breadth, scope, or applicability of the present disclosure. It should be noted that for clarity and ease of illustration these drawings are not necessarily drawn to scale.

FIG. 1A illustrates an exemplary wireless communication network, in accordance with some embodiments of the present disclosure.

FIG. 1B illustrates a block diagram of an exemplary wireless communication system, in accordance with some embodiments of the present disclosure.

FIG. 2A illustrates a conventional signaling diagram for channel estimation in a wireless communication network.

FIG. 2B illustrates another reference signal-based conventional signaling diagram for channel estimation in a wireless communication network.

FIG. 3 illustrates an exemplary wireless communication network for wireless communication, sensing and positioning, in accordance with some embodiments of the present disclosure.

FIG. 4 illustrates another exemplary wireless communication network for wireless communication, sensing and positioning, in accordance with some embodiments of the present disclosure.

FIG. 5 illustrates a signal reflection diagram, in accordance with some embodiments of the present disclosure.

FIG. 6 illustrates an exemplary channel status information physical layer structure for orthogonal frequency division multiplexing-based systems, in accordance with some embodiments of the present disclosure.

FIG. 7A illustrates an exemplary diagram of a communication link between base station antennas and intelligent reflection surface installed user equipment, in accordance with some embodiments of the present disclosure.

FIG. 7B illustrates an example of detection range enhancement by intelligent reflection surface gain, in accordance with some embodiments of the present disclosure.

FIG. 8A illustrate an exemplary intelligent reflection surface antenna group configuration, in accordance with some embodiments of the present disclosure.

FIG. 8B illustrate another exemplary intelligent reflection surface antenna group configuration, in accordance with some embodiments of the present disclosure.

FIG. 9A illustrates an exemplary wireless communication diagram with intelligent reflection surface configured as a single antenna, in accordance with some embodiments of the present disclosure.

FIG. 9B illustrates another exemplary wireless communication diagram with intelligent reflection surface configured as multiple antennas, in accordance with some embodiments of the present disclosure.

FIG. 10 illustrates an exemplary signaling diagram for intelligent reflection surface installed user equipment channel estimation, in accordance with some embodiments of the present disclosure.

FIG. 11 illustrates an example method for performing intelligent reflection surface installed user equipment channel estimation, in accordance with some embodiments of the present disclosure.

### DETAILED DESCRIPTION OF EXEMPLARY EMBODIMENTS

Various exemplary embodiments of the present disclosure are described below with reference to the accompanying figures to enable a person of ordinary skill in the art to make and use the present disclosure. As would be apparent to those of ordinary skill in the art, after reading the present disclosure, various changes or modifications to the examples described herein can be made without departing from the scope of the present disclosure. Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

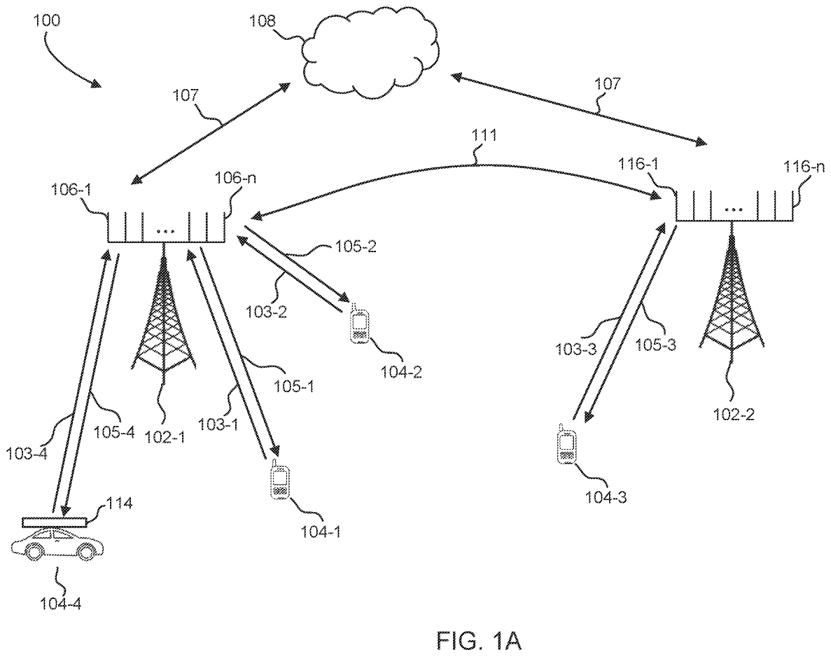

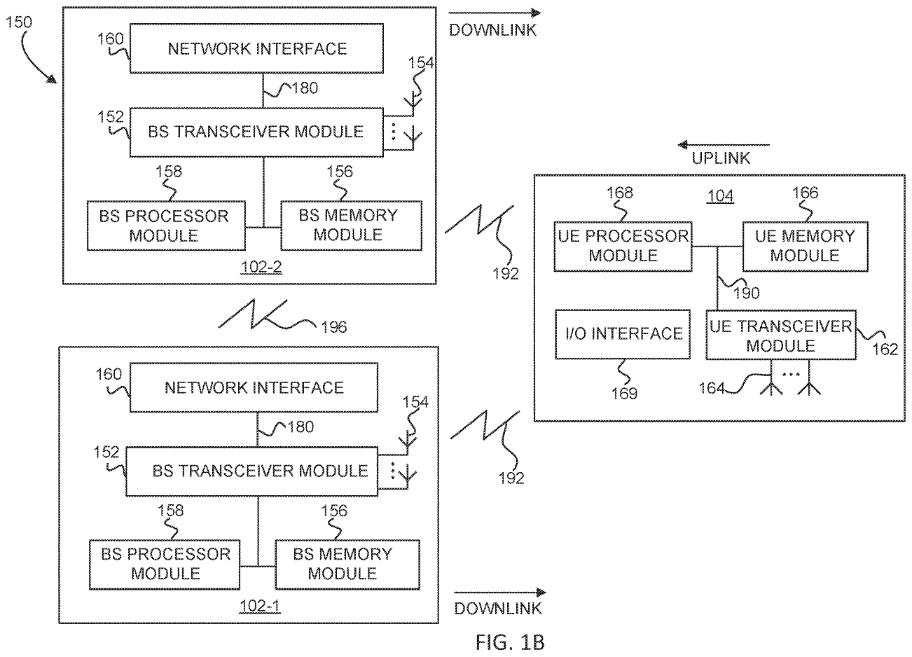

FIG. 1A illustrates an exemplary wireless communication network 100, in accordance with some embodiments of the present disclosure. In a wireless communication system, a network side communication node or a base station (BS) 102 can be a node B, an E-UTRA Node B (also known as Evolved Node B, eNodeB or eNB), a New Generation eNB (ng-eNB), a gNodeB (also known as gNB) in new radio (NR) technology, a pico station, a femto station, or the like. A terminal side communication device or a user equipment (UE) 104 can be a long range communication system like a mobile phone, a smart phone, a personal digital assistant (PDA), tablet, laptop computer, or a short range communication system such as, for example a wearable device, a vehicle with a vehicular communication system and the like. A network communication node and a terminal side communication device are represented by a BS 102 and a UE 104, respectively, and in all the embodiments in this disclosure hereafter, and are generally referred to as “communication nodes” and “communication device” herein. Such communication nodes and communication devices may be capable of wireless and/or wired communications, in accordance with various embodiments of the invention. It is noted that all the embodiments are merely preferred examples, and are not intended to limit the present disclosure. Accordingly, it is understood that the system may include any desired combination of BSs 102 and UEs 104, while remaining within the scope of the present disclosure.

Referring to FIG. 1A, the wireless communication network 100 includes a first BS 102-1, a second BS 102-2, a first UE 104-1, a second UE 104-2, a third UE 104-3, and a fourth UE 104-4. In some embodiments, the first BS 102-1 and the second BS 102-2 comprise a first plurality of antennas 106-1 to 106-n and a second plurality of antennas 116-1 to 116-n, respectively. The first plurality of antennas 106-1 to 106-n may communicate with a plurality of UEs 104 to form a first multiple-input multiple-output (MIMO) system, and the second plurality of antennas 116-1 to 116-n may communicate with the plurality of UEs 104 to form a second MIMO system.

In some embodiments, a plurality of UEs 104 may form direct communication (i.e., uplink) channels 103-1, 103-2, 103-3, and 103-4 with the first BS 102-1 and the second BS 102-2. In some embodiments, the plurality of UEs 104 may also form direct communication (i.e., downlink) channels 105-1, 105-2, 105-3, and 105-4 with the first BS 102-1 and the second BS 102-2. The direct communication channels between the plurality of UEs 104 and a distributed unit of the BS 102 can be through interfaces such as an Uu interface, which is also known as E-UTRAN air interface. In some embodiments, the UE 104 comprises a plurality of transceivers which enables the UE 104 to support multi connectivity so as to receive data simultaneously from the first BS 102-1 and the second BS 102-2. The first BS 102-1 and the second BS 102-2 each is connected to a core network (CN) 108 on a user plane (UP) through an external interface 107, e.g., an Iu interface, an NG-U interface, or an S1-U interface. In some embodiments, the CN 108 is one of the following: an Evolved Packet Core (EPC) and a 5G Core Network (5GC). In some embodiments, the CN 108 further comprises at least one of the following: Access and Mobility Management Function (AMF), User Plane Function (UPF), and System Management Function (SMF).

A direct communication channel 111 between the first BS 102-1 and the second 102-2 is through an X2 interface. In some embodiments, a BS (gNB) is split into a Distributed Unit (DU) and a Central Unit (CU) on the UP, between which the direct communication is through a F1-U interface. In some embodiments, a CU of the second BS 102-2 can be further split into a Control Plane (CP) and a User Plane (UP), between which the direct communication is through an E1 interface. Hereinafter in the present disclosure, an Xx interface is used to describe one of the following interfaces, the NG interface, the S1 interface, the X2 interface, the Xn interface, the F1 interface, and the E1 interface. When an Xx interface is established between two nodes, the two nodes can transmit control signaling on the CP and/or data on the UP.

In some embodiments, one of the plurality of UEs 104, such as the UE 104-4 may comprise an Intelligent Reflecting Surface (IRS) 114 attached to the main body of the UE 104-4. The IRS 114 may be referred to as a planar surface comprising a plurality of small, reconfigurable reflecting elements, each of which can induce a controllable amplitude, phase and/or polarization change to the incident signal independently, without any need of baseband processing. In one embodiment, the UE 104-4 is a vehicle, and the IRS 114 may be installed on the roof of the UE 104-4. In another embodiment, the IRS 114 is installed on mobile robots of the UE 104-4. In yet another embodiment, the UE 104-4 is an uncrewed aerial vehicle (UAV) and the IRS 114 is placed facing the ground. In still another embodiment, the UE 104-4 is a handheld device, and the IRS 114 is installed on the UE 104-4. In some embodiments, the UE 104-4 is connected to the IRS 114 through a wire while the UE 104-4 and the IRS 114 are located at different locations. In still another embodiment, the UE 104-4 comprises the IRS 114. In some other embodiments, the UE 104-4 and the IRS 114 are located at different locations, and the UE 104-4 is connected to the IRS 114 through a wireless communication channel using antennas installed on both the UE 104-4 and the IRS 114. In one embodiment, the IRS 114 is configured to reflect incident signals transmitted from the BS 102-1 for positioning estimation of the UE 104-4, while the UE 104-4 and the IRS 114 are located at different locations. In this embodiment, the UE 104-4 may be configured to transmit a UE message (e.g. UE capability message) to the BS 102-1, wherein the UE message comprises the location of the IRS 114 (e.g. distance and direction) relative to the UE 104-4. In this way, the BS 102-1 may determine the exact location of the IRS 114 using the location of the IRS 114 relative to the UE 104-4 and the exact location of the UE 104-4. In another embodiment, the exact location of the IRS 114 is predetermined and transmitted to the BS 102-1 through the UE message. In yet another embodiment, the exact location of the IRS 114 is predetermined and stored in the BS 102-1. In some embodiments, the BS 102-1 is configured to generate incident signals to the UE 104-4, and the UE 104-4 may be configured to reflect the incident signals towards specific directions using the installed IRS 114 for channel estimation between the BS 102-1 and the UE 104-4.

FIG. 1B illustrates a block diagram of an exemplary wireless communication system 150, in accordance with some embodiments of the present disclosure. The system 150 may include components and elements configured to support known or conventional operating features that need not be described in detail herein. In some embodiments, the system 150 can be used to transmit and receive data symbols in a wireless communication environment such as the wireless communication network 100 of FIG. 1A, as described above.

The system 150 generally includes a first BS 102-1, a second BS 102-2, and a UE 104, collectively referred to as BS 102 and UE 104 below for ease of discussion. The first BS 102-1 and the second BS 102-2 each comprises a BS transceiver module 152, a BS antenna array 154, a BS memory module 156, a BS processor module 158, and a network interface 160. In the illustrated embodiment, each module of the BS 102 is coupled and interconnected with one another as necessary via a data communication bus 180. The UE 104 comprises a UE transceiver module 162, a UE antenna 164, a UE memory module 166, a UE processor module 168, and an I/O interface 169. In the illustrated embodiment, each module of the UE 104 is coupled and interconnected with one another as necessary via a date communication bus 190. The BS 102 communicates with the UE 104 via a communication channel 192, which can be any wireless channel or other medium known in the art suitable for transmission of data as described herein.

As would be understood by persons of ordinary skill in the art, the system 150 may further include any number of modules other than the modules shown in FIG. 1B. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present invention.

A wireless transmission from a transmitting antenna of the UE 104 to a receiving antenna of the BS 102 is known as an uplink (UL) transmission, and a wireless transmission from a transmitting antenna of the BS 102 to a receiving antenna of the UE 104 is known as a downlink (DL) transmission. In accordance with some embodiments, the UE transceiver 162 may be referred to herein as an “uplink” transceiver 162 that includes a radio frequency (RF) transmitter and receiver circuitry that is each coupled to the UE antenna 164. A duplex switch (not shown) may alternatively couple the uplink transmitter or receiver to the uplink antenna in time duplex fashion. Similarly, in accordance with some embodiments, the BS transceiver 152 may be referred to herein as a “downlink” transceiver 152 that includes RF transmitter and receiver circuitry that are each coupled to the antenna array 154. A downlink duplex switch may alternatively couple the downlink transmitter or receiver to the downlink antenna array 154 in time duplex fashion. The operations of the two transceivers 152 and 162 are coordinated in time such that the uplink receiver is coupled to the uplink UE antenna 164 for reception of transmissions over the wireless communication channel 192 at the same time that the downlink transmitter is coupled to the downlink antenna array 154. Preferably, there is close synchronization timing with only a minimal guard time between changes in duplex direction. The UE transceiver 162 communicates through the UE antenna 164 with the BS 102 via the wireless communication channel 192. The BS transceiver 152 communications through the BS antenna 154 of a BS (e.g., the first BS 102-1) with the other BS (e.g., the second BS 102-2) via a wireless communication channel 196. The wireless communication channel 196 can be any wireless channel or other medium known in the art suitable for direct communication between BSs.

The UE transceiver 162 and the BS transceiver 152 are configured to communicate via the wireless data communication channel 192, and cooperate with a suitably configured RF antenna arrangement 154/164 that can support a particular wireless communication protocol and modulation scheme. In some exemplary embodiments, the UE transceiver 162 and the BS transceiver 152 are configured to support industry standards such as the Long Term Evolution (LTE) and emerging 5G standards (e.g., NR), and the like. It is understood, however, that the invention is not necessarily limited in application to a particular standard and associated protocols. Rather, the UE transceiver 162 and the BS transceiver 152 may be configured to support alternate, or additional, wireless data communication protocols, including future standards or variations thereof.

The processor modules 158 and 168 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 158 and 168, respectively, or in any practical combination thereof. The memory modules 156 and 166 may be realized as RAM memory, flash memory, ROM memory, EPROM memory, EEPROM memory, registers, a hard disk, a removable disk, a CD-ROM, or any other form of storage medium known in the art. In this regard, the memory modules 156 and 166 may be coupled to the processor modules 158 and 168, respectively, such that the processors modules 158 and 168 can read information from, and write information to, memory modules 156 and 166, respectively. The memory modules 156 and 166 may also be integrated into their respective processor modules 158 and 168. In some embodiments, the memory modules 156 and 166 may each include a cache memory for storing temporary variables or other intermediate information during execution of instructions to be executed by processor modules 158 and 168, respectively. The memory modules 156 and 166 may also each include non-volatile memory for storing instructions to be executed by the processor modules 158 and 168, respectively.

The network interface 160 generally represents the hardware, software, firmware, processing logic, and/or other components of the base station 102 that enable bi-directional communication between BS transceiver 152 and other network components and communication nodes configured to communication with the BS 102. For example, network interface 160 may be configured to support internet or WiMAX traffic. In a typical deployment, without limitation, network interface 160 provides an 802.3 Ethernet interface such that BS transceiver 152 can communicate with a conventional Ethernet based computer network. In this manner, the network interface 160 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 160 could allow the BS 102 to communicate with other BSs or a CN over a wired or wireless connection.

Referring again to FIG. 1A, as mentioned above, the BS 102 repeatedly broadcasts system information associated with the BS 102 to one or more UEs 104 so as to allow the UEs 104 to access the network within the cells where the BS 102 is located, and in general, to operate properly within the cell. Plural information such as, for example, downlink and uplink cell bandwidths, downlink and uplink configuration, cell information, configuration for random access, etc., can be included in the system information. Typically, the BS 102 broadcasts a first signal carrying some major system information, for example, configuration of the cell where the BS 102 is located through a Physical Broadcast Channel (PBCH). For purposes of clarity of illustration, such a broadcasted first signal is herein referred to as “first broadcast signal.” It is noted that the BS 102 may subsequently broadcast one or more signals carrying some other system information through respective channels (e.g., a Physical Downlink Shared Channel (PDSCH)).

Referring again to FIG. 1B, in some embodiments, the major system information carried by the first broadcast signal may be transmitted by the BS 102 in a symbol format via the communication channel 192 (e.g., a PBCH). In accordance with some embodiments, an original form of the major system information may be presented as one or more sequences of digital bits and the one or more sequences of digital bits may be processed through plural steps (e.g., coding, scrambling, modulation, mapping steps, etc.), all of which can be processed by the BS processor module 158, to become the first broadcast signal. Similarly, when the UE 104 receives the first broadcast signal (in the symbol format) using the UE transceiver 162, in accordance with some embodiments, the UE processor module 168 may perform plural steps (de-mapping, demodulation, decoding steps, etc.) to estimate the major system information such as, for example, bit locations, bit numbers, etc., of the bits of the major system information. The UE processor module 168 is also coupled to the I/O interface 169, which provides the UE 104 with the ability to connect to other devices such as computers. The I/O interface 169 is the communication path between these accessories and the UE processor module 168.

Referring again to FIG. 1A, during the transmission of signals between the BS 102 and the UE 104, the established wireless transmission channels between the BS 102 and the UE 104 may introduce various impairments and distortions to the transmitted signals due to factors such as fading, interference, and noise. Channel estimation can be performed to estimate the characteristics of the communication channel between the BS 102 and the UE 104 to optimize wireless communication system performance and to improve the reliability of communication. A conventional way to perform channel estimation is to use channel reciprocity for MIMO precoding in the downlink by estimating the UL channel based on the symmetry properties between the UL and DL channels. That is, the UE 104 can periodically transmit pilot signals or Sounding Reference Signals (SRSs) during specific time slots allocated for UL channel sounding, and the corresponding BS 102 can measures the received SRSs to estimate the UL channel characteristics such as channel gains and phases. In case of a time-division duplexing (TDD) transmission, there is channel reciprocity between the UL and DL channels. This means that the UL and DL channel responses are related, allowing information obtained from UL measurements to be used for DL transmission. For example, the BS 102 can perform DL MIMO precoding based on the extracted UL channel state information (CSI) from the received pilot signals or SRSs. Once the DL MIMO precoding matrix is determined, the BS 102 can use it to precode the DL data transmission, which helps in mitigating the effects of channel fading and interference and improving the quality of the received signal at the UEs. However, this method suffers from the fact that SRS resources are limited and if many UEs need to be accommodated, these SRS resources need to be reused, thus creating interference, which limits the accuracy of channel estimation and hence MIMO performance. Although several schemes to mitigate this problem, such as SRS multiplexing in the time and frequency domain, SRS cyclic shift hopping or combinations of all these, the SRS interference issue remains a limiting factor for reciprocity-based MIMO in currently deployed systems.

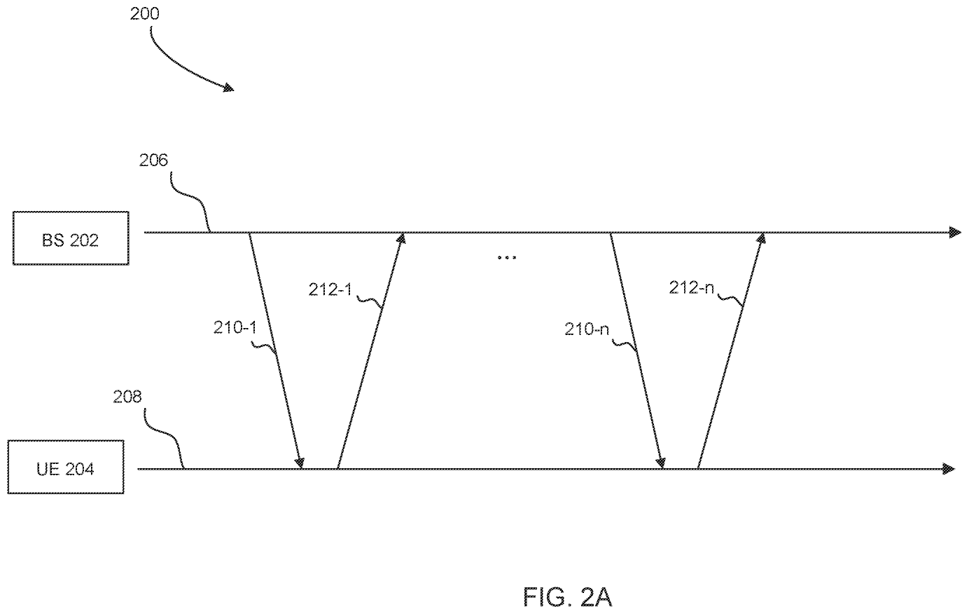

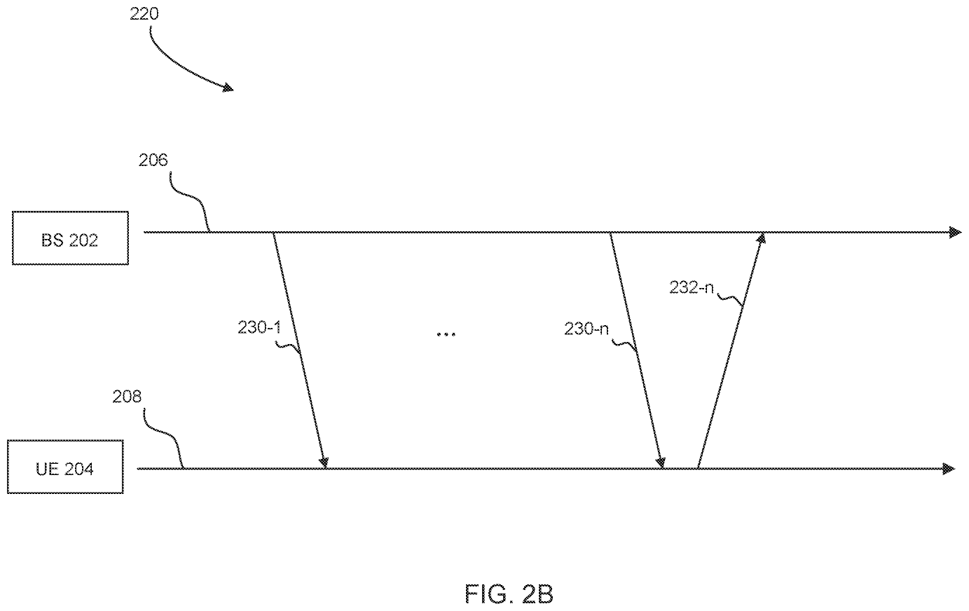

Another conventional method for estimating the channel, applicable to both TDD and frequency division duplex (FDD), is performed by the UE 104 wherein the UE 104 uses Channel State Information Reference Signals (CSI-RS) transmitted from the BS 102 to generate a Channel State Information (CSI) report that comprises: Precoding Matrix Indicator (PMI), Rank Indicator (RI) and Channel Quality Indicator (CQI). FIG. 2A illustrates an exemplary signaling diagram 200 of such method. As can be seen, a BS 202 may be configured to periodically transmit known pilot signals 210-1 to 210-n to a UE 204 during specific time slots represented on a BS time axis 206, wherein the pilot signals 210-1 to 210-n are known to both the BS 202 and the UE 204. The UE 204 may then use the pilot signals 210-1 to 210-n to estimate the channel characteristics. That is, during the reception of the pilot signals 210-1 to 210-n, the UE 204 may measure the received signal strength, phase, and other relevant parameters, and use these parameters to estimate the channel characteristics between the UE 204 and the BS 202.

After performing the channel estimation, the UE 204 may be configured to send feedback signals 212-1 to 212-n back to the BS 202 along a UE time axis 208, wherein each of the feedback signals 212-1 to 212-n may comprise a CSI report that comprises at least one of: a PMI, an RI and a CQI. The BS 202 may then use the feedback signals 212-1 to 212-n to adapt its transmission parameters, such as modulation, coding, and beamforming in a precoding process, to optimize communication with the UE 204. For transmission with medium and high speeds, this method has been found to suffer from the “channel aging” problem. That is, that by the time the BS 202 receives the feedback signals 212 generated from the UE 204, the CSI report included in the feedback signals 212 may become dated as the channel condition has changed significantly during the UE measurement and UE reporting interval.

One major reason for the “channel aging” problem is that the UE 204 needs a significant amount of time to compute the CSI report, and when the CSI report is completed, the channel condition may have changed significantly. The time that the UE 204 needs to compute the CSI report is known as “CSI computation delay”. Tables 1 and 2 below show two examples of CSI computation delay requirements given in TS 38.214 document of the 3rd Generation Partnership Project (3GPP). The parameter u in Tables 1 and 2 corresponds to min(μPDCCH, μCSI-RS, μUL), where the μPDCCH corresponds to the subcarrier spacing (SCS) of the Physical Downlink Control Channel (PDCCH) with which the Downlink Control Information (DCI) was transmitted, μUL corresponds to the subcarrier spacing of the Physical Uplink Shared Channel (PUSCH) with which the CSI report is to be transmitted, and μCSI-RS corresponds to the minimum subcarrier spacing of the aperiodic CSI-RS triggered by the DCI. The parameters Zi and Z′i are defined as next uplink symbols with different cyclic prefix (CP) starting conditions.

TABLE 1
CSI computation delay requirement 1

| | | | | CSI computation delay (msec) | |
|---|---|---|---|---|---|
| | SCS | Z₁ [symbols] | | PDCCH | Aperiodic |
| μ | (kHz) | Z₁ | Z′₁ | triggered CSI | CSI |
| 0 | 15 | 10 | 8 | 0.71 | 0.57 |
| 1 | 30 | 13 | 11 | 0.46 | 0.39 |
| 2 | 60 | 25 | 21 | 0.45 | 0.37 |
| 3 | 120 | 43 | 36 | 0.38 | 0.32 |

TABLE 2
CSI computation delay requirement 2

| | | | | CSI computation | | | | CSI computation | |
|---|---|---|---|---|---|---|---|---|---|
| | | | | Delay (msec) | | | | Delay (msec) | |
| | | Z₁ | | PDCCH | | | | PDCCH | |
| | SCS | [symbols] | | triggered | Aperiodic | Z₂ [symbols] | | triggered | Aperiodic |
| μ | (kHz) | Z₁ | Z′₁ | CSI | CSI | Z₂ | Z′₂ | CSI | CSI |
| 0 | 15 | 22 | 16 | 1.57 | 1.14 | 40 | 37 | 2.85 | 2.64 |
| 1 | 30 | 33 | 30 | 1.18 | 1.07 | 72 | 69 | 2.57 | 2.46 |
| 2 | 60 | 44 | 42 | 0.78 | 0.75 | 141 | 140 | 2.52 | 2.50 |
| 3 | 120 | 97 | 85 | 0.87 | 0.76 | 152 | 140 | 1.36 | 1.25 |
| 5 | 480 | 388 | 340 | 0.87 | 0.76 | 608 | 560 | 1.36 | 1.25 |
| 6 | 960 | 776 | 680 | 0.87 | 0.76 | 1216 | 1120 | 1.36 | 1.25 |

As can be observed in Tables 1-2, for some conditions, the CSI computation time can reach approximately 3 millisecond (ms), which amounts to 30% of a radio frame (10 ms). Even a CSI computation of 1 ms consumes the latency requirement for some of the most stringent delay-sensitive applications, such as Ultra-Reliable Low Latency Communications (URLLC) applications which target an end-to-end delay of 1 ms.

To overcome the above-mentioned problems, complex channel prediction schemes have been proposed in the prior art. For example, FIG. 2B illustrates another exemplary signaling diagram 220 of a conventional reference signal-based channel estimation method. As can be seen, the BS 202 may be configured to periodically transmit known pilot signals 230-1 to 230-n to the UE 204 during specific time slots represented on the BS time axis 206, wherein the pilot signals 230-1 to 230-n are known to both the BS 202 and the UE 204. Instead of using each of the pilot signals 230-1 to 230-n to directly estimate the channel characteristics, the UE 204 can use the received pilot signals 230-1 to 230-n to predict channel variations. For example, upon receiving the pilot signal 230-n, the UE 204 uses the pilot signal 230-n along with some previously received pilot signals including 230-1 to predict Doppler precoder and perform Doppler compression, and then the UE 204 can report the predicted precoder back to the BS 202 using the feedback signal 232-n. However, this solution suffers from two problems: first, the delay in computing CSI is not eliminated since it takes a finite amount of time to accumulate enough pilot signal measurements and to compute the prediction. Second, this method may significantly increase UE complexity and power consumption. Therefore, there is a need to develop new methods and systems for improving the efficiency and accuracy in RS-based UE channel estimation.

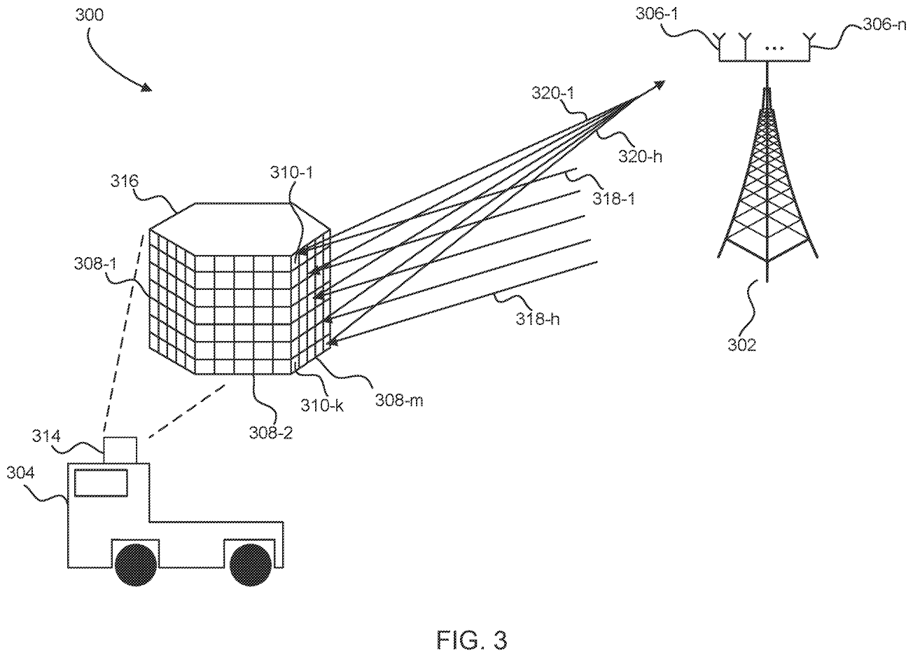

FIG. 3 illustrates an exemplary wireless communication network 300 for wireless communication, sensing and positioning, in accordance with some embodiments of the present disclosure. In some embodiments, the exemplary wireless communication network 300 comprises a BS 302 and a UE 304. In some embodiments, the BS 302 comprises a plurality of antennas 306-1 to 306-n as shown. The plurality of antennas 306-1 to 306-n may be arranged in an antenna array and be in communication with the UE 304 to form a multiple input and single output (MISO) system. In some embodiments, the plurality of antennas 306-1 to 306-n is configured to form a uniform linear antenna array. In some other embodiments, the plurality of antennas 306-1 to 306-n may form a planar antenna array or a frequency scanning antenna array. Although FIG. 3 illustrates an embodiment of a MISO system, the present disclosure is not limited to MISO systems, and can be applied to other types of communication systems, such as multiple input multiple output (MIMO) systems, single input multiple output (SIMO) systems, and single input single output (SISO) systems having corresponding antenna configurations. In some embodiments, the UE 304 comprises an IRS that includes a plurality of antennas that can provide multiple outputs in a MIMO system. In some embodiments, the antennas in the plurality of antennas 306-1 to 306-n are evenly spaced on a straight line, wherein each pair of neighbored antennas has a fixed distance. In some other embodiments, the antennas in the plurality of antennas 306-1 to 306-n are arranged on a straight line, wherein different pairs of neighbored antennas have different distances.

In some embodiments, the UE 304 comprises an IRS 314 attached to the main body of the UE 304. In some other embodiments, the UE 304 is a vehicle, and the IRS 314 may be installed on the roof of the UE 304. In yet some other embodiments, the IRS 314 is installed on mobile robots of the UE 304. In still some other embodiments, the UE 304 is a UAV and the IRS 314 is placed facing the ground. In still some other embodiments, the UE 304 is a handheld device, and the IRS 314 is installed on the UE 304. The UE 304 may be connected to the IRS 314 through a wire or a wireless communication channel while the UE 304 and the IRS 314 are located at different locations.

In some embodiments, the IRS 314 comprises one or more intelligent reflection surfaces. A zoomed view 316 of the IRS 314 is shown in FIG. 3. In some embodiments, the zoomed view 316 of the IRS 314 comprises a plurality of intelligent reflection surfaces 308-1 to 308-m placed on side surfaces of a polygonal cylinder shape as shown. Each of the intelligent reflection surfaces 308-1 to 308-m may comprises a plurality of reconfigurable reflecting elements. For example, the intelligent reflection surface 308-m may comprise a plurality of reconfigurable reflecting elements 310-1 to 310-k. In one embodiment, each of the plurality of reconfigurable reflecting elements 310-1 to 310-k comprises a respective metallic patch printed on a dielectric substrate, and each of the respective metallic patches can be configured to manipulate incident signals. In some other embodiments, a control circuit board installed in the IRS 314 can be configured to activate the plurality of reconfigurable reflecting elements 310-1 to 310-k.

In some embodiments, the plurality of antennas 306-1 to 306-n in the BS 302 may be in communication with the respective plurality of reconfigurable reflecting elements in each of the plurality of intelligent reflection surfaces 308-1 to 308-m to form a MIMO system. For example, the plurality of antennas 306-1 to 306-n and the plurality of reconfigurable reflecting elements 310-1 to 310-k may form a first MIMO system for positioning estimation of the UE 304. In the first MIMO system, the BS 302 comprising the plurality of antennas 306-1 to 306-n may be configured to transmit a first plurality of signals 318-1 to 318-h to the plurality of reconfigurable reflecting elements 310-1 to 310-k, wherein each of the plurality of reconfigurable reflecting elements 310-1 to 310-k are configured to receive the first plurality of signals 318-1 to 318-h. Upon receiving the first plurality of signals 318-1 to 318-h, each of the plurality of reconfigurable reflecting elements 310-1 to 310-k may be configured to reflect the first plurality of signals 318-1 to 318-h to produce a respective one of a plurality reflected second signals 320-1 to 320-h. In some embodiments, for the first plurality of signals 318-1 to 318-h received at the IRS 314, a respective AoA at each of the plurality of reconfigurable reflecting elements 310-1 to 310-k is slightly different due to slight different locations of each of the plurality of reconfigurable reflecting elements 310-1 to 310-k. In such a case, the amplitude and/or phase shifts in each of the plurality of reconfigurable reflecting elements 310-1 to 310-k may be jointly adjusted such that each of the plurality of reconfigurable reflecting elements 310-1 to 310-k reflects the first plurality of signals 318-1 to 318-h at its respective AoA to form a beam that reaches the destination node with the maximum power. In some embodiments, each of the plurality of reconfigurable reflecting elements 310-1 to 310-k reflects the first plurality of signals 318-1 to 318-h to generate a respective one of a plurality of reflected second signals 320-1 to 320-h, such that the plurality of reflected second signals 320-1 to 320-h is focused towards the transmission node BS 302. In some embodiments, the plurality of reflected second signals 320-1 to 320-h forms a beam that reaches the destination node with the maximum power. In some embodiments, the power value of the beam formed by the plurality reflected second signals 320-1 to 320-h is larger than the corresponding power value in each of the plurality reflected second signals 320-1 to 320-h.

In one embodiment, the plurality of reconfigurable reflecting elements 310-1 to 310-k is adjusted by mechanical actuation via mechanical rotation to control the directions of the plurality reflected second signals 320-1 to 320-h. In another embodiment, the plurality of reconfigurable reflecting elements 310-1 to 310-k is adjusted by functional materials such as liquid crystal or graphene. In yet another embodiment, the plurality of reconfigurable reflecting elements 310-1 to 310-k is adjusted by electronic devices such as positive-intrinsic-negative (PIN) diodes, field-effect transistors (FETs), or micro-electromechanical system (MEMS) switches. The electronic devices used for controlling reflection of incident signals may provide fast response time, low reflection loss as well as relatively low energy consumption and hardware cost.

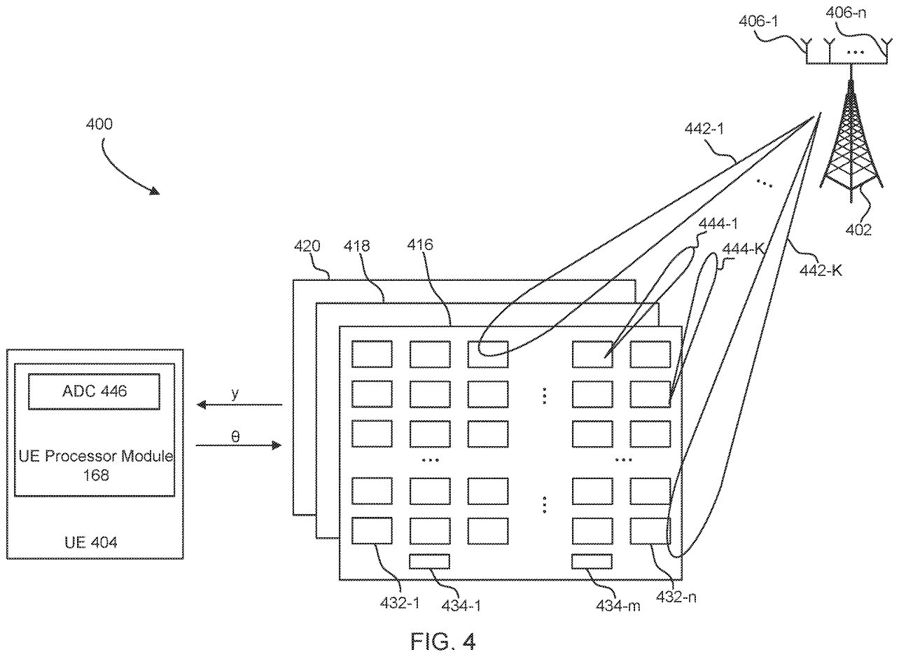

FIG. 4 illustrates another exemplary wireless communication network 400 for wireless communication, sensing and positioning, in accordance with some embodiments of the present disclosure. In some embodiments, the IRS 314 as shown in FIG. 3 may be in communication with a BS 402 comprising a plurality of antennas 406-1 to 406-n for UE positioning estimation of a UE 404, wherein the IRS 314 comprises a first/outside layer 416, a second/intermediate layer 418 and a third/inside layer 420.

In some embodiments, the first/outside layer 416 comprises a plurality of reconfigurable reflecting elements 432-1 to 432-n. In one embodiment, each of the plurality of reconfigurable reflecting elements 432-1 to 432-n comprises a respective metallic patch printed on a dielectric substrate, and each of the respective metallic patches can be configured to manipulate incident signals. In some other embodiments, the second/intermediate layer 418 comprises a copper plate used to reduce signal energy leakage during IRS's reflection. In yet some other embodiments, the third/inside layer 420 comprises a control circuit board, wherein the control circuit board can be configured to activate the plurality of reconfigurable reflecting elements 432-1 to 432-n. In some embodiments, the control circuit board in the third/inside layer 420 is configured to tune the reflection amplitude and/or phase shifts in each of the reconfigurable reflecting elements 432-1 to 432-n at real time. In some embodiments, the UE 404 comprising the UE processor module 168 shown in FIG. 1B may be coupled to the IRS 314 for controlling operations in the control circuit board in the third/inside layer 420. In one embodiment, the UE processor module 168 acts as a gateway to communicate with other network components in the network through wired or wireless backhaul/control links.

In some embodiments, a plurality of sensors 434-1 to 434-m can be deployed in the first/outside layer 416 to enhance the environmental learning capability of the IRS 314. In one embodiment, each of the plurality of reconfigurable reflecting elements 432-1 to 432-n is associated with a respective sensor from the plurality of sensors 434-1 to 434-m. In another embodiment, the plurality of sensors 434-1 to 434-m is interlaced with the plurality of reconfigurable reflecting elements 432-1 to 432-n in the first/outside layer 416. In yet another embodiment, each of the plurality of sensors 434-1 to 434-m is configured to sense the surrounding radio signals of interest to facilitate the UE Processor Module 168 in designing the reflection coefficient for the respective one of the plurality of reconfigurable reflecting elements 432-1 to 432-n.

In some embodiments, the plurality of sensors 434-1 to 434-m is configured to receive incident signals from the BS 402. Upon receiving the incident signals from the BS 402, the plurality of sensors 434-1 to 434-m may be configured to down convert the received incident signals into analog signals using frequency translation to shift the original radio frequency (RF) incident signals to analog signals of lower frequency. In some embodiments, signal filtering and amplification can also be performed in the down-conversion process. Once the incident signals are down converted into analog signals, as shown by the analog signal y in FIG. 4, the analog signal y may be transmitted from the IRS 314 to the UE processor module 168, wherein the UE processor module 168 comprises an analog-to-digital convertor (ADC) 446 to convert the analog signal y to corresponding digital baseband signals for digital baseband processing. Using the digital baseband signals from the output of the ADC 446, the UE processor module 168 may be configured to estimate the angle of arrival (AoA) of the received incident signals from the BS 402, as well as the distance between the IRS 314 and the transmitting node BS 402. Examples of algorithms that can be applied to estimate the AoA of the received incident signals from the BS 402 and the distance between the IRS 314 and the transmitting node BS 402 include Capon's Minimum Variance, MUltiple SIgnal Classification (MUSIC), Estimation of Signal Parameters via Rotational Invariance Techniques (ESPRIT), and Matrix-Pencil method. In this way, UE positioning estimation can be performed by receiving reference signals from a single transmitting point such as the BS 402.

Relative to conventional positioning methods, one of the most significant advantages with the exemplary architecture of IRS for UE positioning shown in FIG. 4 is the energy savings and reduced signaling overhead. Upon receiving a plurality of reference incident signals 442-1 to 442-K from the BS 402, the UE 404 comprising the UE processor module 168 is not required to transmit positioning measurement reports back to the serving BS 402. Instead, the IRS 314 comprising the plurality of reconfigurable reflecting elements 432-1 to 432-n is configured to reflect the plurality of reference incident signals 442-1 to 442-K to produce a plurality of reflected signals 444-1 to 444-K for UE positioning estimation. Since no data transmissions are needed at the UE 404 during the incident signal reflection, the UE 404 does not establish a connection with the serving BS 402 during the IRS reflection procedure. This allows the UE 404 not to be in the CONNECTED state during the positioning process. In some embodiments, a new POSITIONING state may be used during the IRS reflection procedure, wherein the UE 404 is in a listen-only mode in the new POSITIONING state. In some other embodiments, the UE 404 and the coupled IRS 314 are configured by the network for IRS reflection.

In some embodiments, the BS 402 may receive a measurement initiation request from a location management server (LMS), wherein the measurement initiation request may be a new radio (NR) Reference Signal Received Power (RSRP) measurement initiation request, an NR Reference Signal Received Quality (RSRQ) measurement initiation request, an Enhanced Cell Identity (E-CID) measurement initiation request message, an Evolved Universal Terrestrial Radio Access Network Reference Signal Received Power (E-UTRA RSRP) measurement initiation request message, Evolved Universal Terrestrial Radio Access Network Reference Signal Received Quality (E-UTRA RSRQ) measurement initiation request message, or an Observed Time Difference Of Arrival (OTDOA) measurement initiation request message. In some embodiments, the measurement initiation request may indicate a request for UE positioning based on IRS. In some other embodiments, to optimize beam management, the BS 402 may request the LMS to initiate a UE positioning calculation procedure for the UE 404.

In some embodiments, the measurement initiation request comprises downlink positioning reference signal (DL-PRS) configurations, wherein the DL-PRS configurations comprise at least one of: positioning reference signal (PRS) resources, muting resources, PRS pattern and periodicity, and a list of measurements to be reported back to the core network, wherein the list of measurements comprises at least one of: a Round-Trip-Delay (RTD), a Time-of-Arrival (ToA), a Received Signal Received Power (RSRP), an Angle-of-Arrival (AoA), and an Angle-of-Departure (AoD) of the PRS transmission. In some other embodiment, the DL-PRS configurations are pre-configured in the BS 402. In yet some another embodiments, the DL-PRS configurations are pre-configured in the UE 404, and the UE 404 is pre-configured to reflect incident signals from the BS 402 towards the same direction as the incident signals.

In some embodiments, upon receiving the measurement initiation request, the BS 402 may transmit a first signal to the UE 404 for performing UE positioning. In some embodiments, the first signal comprises an indication to instruct the UE 404 to receive and reflect DL-PRS back towards the corresponding transmitting node that sends the DL-PRS. In some embodiments, the indication instructs the UE 404 to reflect the DL-PRS back to the corresponding transmitting node using the IRS 314. In some other embodiments, the indication instructs the UE 404 to reflect the DL-PRS back to the corresponding transmitting node in the same direction of the incident DL-PRS.

In some embodiments, the first signal sent from the BS 402 to the UE 404 may be transmitted through system information block (SIB) signaling, radio resource control (RRC) signaling, medium access control-control element (MAC-CE) signaling, or downlink control information (DCI) signaling. In some other embodiments, the indication for instructing the UE 404 to reflect the DL-PRS may be pre-configured in the UE 404 or sent to the UE 404 from the BS 402 via a paging message. In one embodiment, the first signal is transmitted through an SIB Type 1 (SIB1) signaling message, wherein the SIB1 signaling message is periodically transmitted from the BS 402 to the UE 404, such that the SIB1 signaling message can be transmitted to the UE 404 even when the UE 404 is still in IDLE or INACTIVE state.

After transmitting the first signal to the UE 404, the BS 402 may be configured to transmit a plurality of second signals to the UE 404. In some embodiments, the plurality of second signals comprises reference signals for channel estimation. In some other embodiments, each of the plurality of second signals comprises a respective DL-PRS with a respective AoA for performing UE positioning for the UE 404, wherein the respective DL-PRS comprises resource allocation information for downlink transmission, modulation and coding schemes, and pilot/reference signals for UE positioning measurements. Upon receiving each of the plurality of second signals, the UE 404 may be configured to measure the respective AoA (e.g. θ₁, . . . , θₖ) for each of the plurality of second signals using the plurality of sensors 434-1 to 434-m.

In some embodiments, once the respective AoA for each of the plurality of second signals is measured, the IRS 314 may be configured to reflect each of the plurality of second signals back towards the transmitting node BS 402 with the same direction as measured in the respective AoA for each of the plurality of second signals. In one embodiment, the IRS 314 comprises the plurality of reconfigurable reflecting elements 432-1 to 432-n and the plurality of sensors 434-1 to 434-m, and the plurality of reconfigurable reflecting elements 432-1 to 432-n is coordinated to reflect each of the plurality of second signals back towards the BS 402 with the same direction as measured in the AoA for each of the plurality of second signals. In another embodiment, the plurality of reconfigurable reflecting elements 432-1 to 432-n is coordinated to focus each of the reflected second signals such that the DL-PRS transmitting node BS 402 receives the reflected second signals at sufficient receive strength.

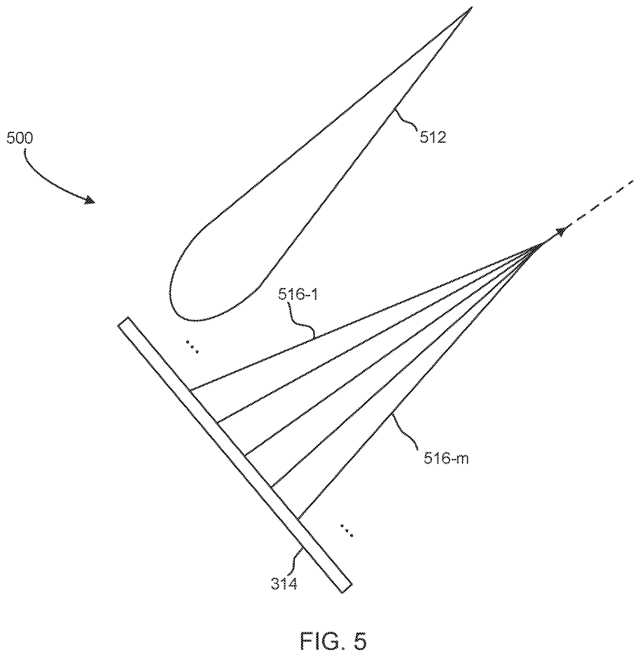

As illustrated in a signal reflection diagram 500 in FIG. 5, upon receiving a second signal 512, each of the plurality of reconfigurable reflecting elements 432-1 to 432-n in the IRS 314 may be configured to reflect the second signal 512 to produce a respective one of a plurality reflected second signals 516-1 to 516-m. In some embodiments, for the second signal 512 received at the IRS 314, a respective AoA at each of the plurality of reconfigurable reflecting elements 432-1 to 432-n is slightly different due to slight different locations of each of the plurality of reconfigurable reflecting elements 432-1 to 432-n. In such a case, the amplitude and/or phase shifts in each of the plurality of reconfigurable reflecting elements 432-1 to 432-n may be jointly adjusted such that each of the plurality of reconfigurable reflecting elements 432-1 to 432-n reflects the second signal 512 at its respective AoA to form a beam that reaches the destination node with the maximum power. In some embodiments, each of the plurality of reconfigurable reflecting elements 432-1 to 432-n reflects the second signal 512 to generate a respective one of a plurality of reflected second signals 516-1 to 516-m, such that the plurality of reflected second signals 516-1 to 516-m is focused towards the transmission node BS 402. In some embodiments, the plurality of reflected second signals 516-1 to 516-m forms a beam that reaches the destination node with the maximum power. In some embodiments, the power value of the beam formed by the plurality reflected second signals 516-1 to 516-m is larger than the corresponding power value in each of the plurality reflected second signals 516-1 to 516-m.

In some embodiments, the first signal transmitted from the BS 402 to the UE 404 comprises an IRS configuration message, wherein the IRS configuration message comprises an indication of the antenna configuration mode in the IRS 314 coupled to the UE 404. In some embodiments, the indication in the IRS configuration message indicates a plurality of parameters that are related to the RS physical layer (PHY) structure and the IRS antenna arrangement in the IRS 314. In some embodiments, in the PHY downlink frame structure, the RSs are allocated to the time-frequency resources. In some other embodiments, one RS can occupy partial/one/multiple symbol time durations and partial/one/multiple subcarriers.

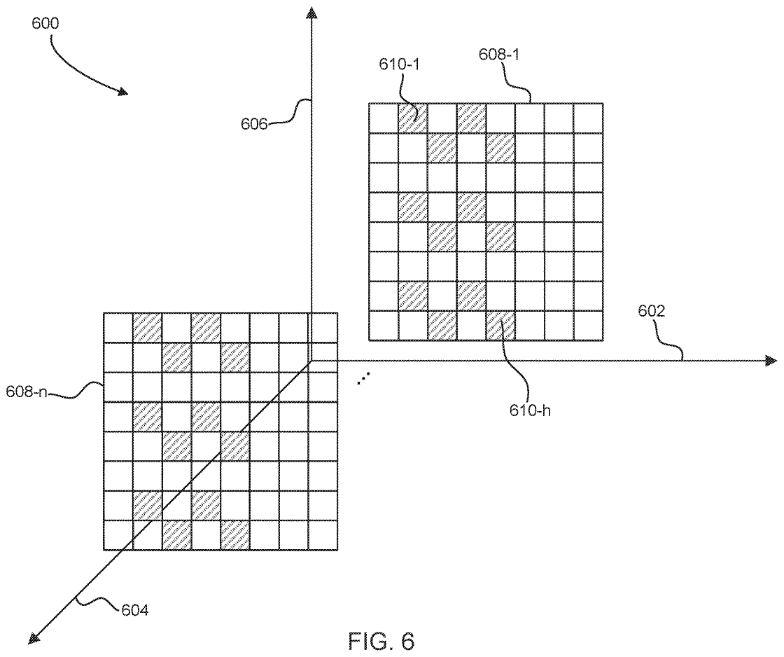

FIG. 6 illustrates an exemplary CSI-RS PHY structure 600 for orthogonal frequency division multiplexing (OFDM) based systems, in accordance with some embodiments of the present disclosure. In some embodiments, the CSI-RS PHY structure 600 comprises an x-axis 602 for OFDM symbols, a y-axis 604 for OFDM spatial layers, and a z-axis 606 for OFDM subcarriers. In some embodiments, the y-axis 604 represents OFDM spatial layers associated with parallel data streams transmitted by multiple antennas in a MIMO implementation. In some embodiments, the y-axis 604 represents a plurality of OFDM spatial layers 608-1 to 608-n, wherein each of the plurality of OFDM spatial layers 608-1 to 608-n is associated with a respective independent data stream transmitted by a specific antenna, and the term “spatial layer” indicates the data stream's transmission through a specific spatial path, taking into account the channel characteristics and antenna configurations. In one embodiment, a UE and a BS form a 2×2 MIMO-OFDM system. In this case, there are two spatial layers, wherein each layer corresponds to the data transmitted or received by one of the two antennas at the UE or the BS. In another embodiment, the UE and the BS form a 3×3 MIMO-OFDM system. In this case, there are three spatial layers, wherein each layer corresponds to the data transmitted or received by one of the three antennas at the UE or the BS.

In some embodiments, the OFDM system associated with the CSI-RS PHY structure 600 comprises parameters nₛ, nᵣ, n_{f} and nₚ, wherein nₛ, nᵣ, n_{f} and nₚ represent symbol separation, pattern repetition, frequency spacing in subcarriers, and periodicity in symbols, respectively. In some embodiments, the RS resources assigned for each of the plurality of OFDM spatial layers 608-1 to 608-n may occupy orthogonal resources. In some other embodiments, the RS resources assigned for each of the plurality of OFDM spatial layers 608-1 to 608-n may be covered or scrambled by orthogonal codes such as Walsh codes.

In some embodiments, CSI-RS PHY structure 600 may be applied to the RSS transmitted from the BS 402 to the IRS 314 coupled to the UE 404. In some embodiments, all the resource elements in each of the plurality of OFDM spatial layers 608-1 to 608-n are assigned for the UE 404 for transmission. In some other embodiments, only a portion of the resource elements in each of the plurality of OFDM spatial layers 608-1 to 608-n is assigned for the UE 404 for transmission, as shown by the resource elements 610-1 to 610-h with upward diagonal pattern fills in FIG. 6. In contrast to the conventional RS transmissions, the RSs reflected from the IRS 314 may reach the transmitting BS 402 with twice as much propagation delay and experience a much greater Doppler shift. Therefore, the RS symbol separation in this case must be nₛ≥└2τₘₐₓ┘, wherein the notation └x┘ denotes the greater integer nearest to x, and τₘₐₓ denotes the maximum one-way propagation delay between the BS 402 and the IRS 314. In addition, the frequency spacing in subcarriers must satisfy n_{f}≥└βf_{Doppler,max}┘ with β≥1, wherein f_{Doppler,max} denotes the maximum Doppler shift of the UE 404 coupled to the IRS 314. In some embodiments, a set of guard subcarriers needs to be put in place at the edge of the channel bandwidth to ensure the orthogonality of the RS symbols.

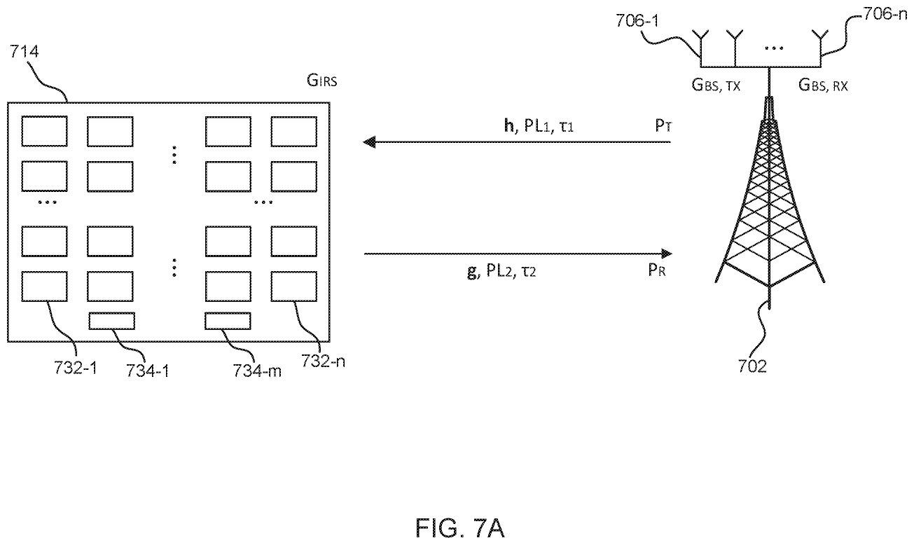

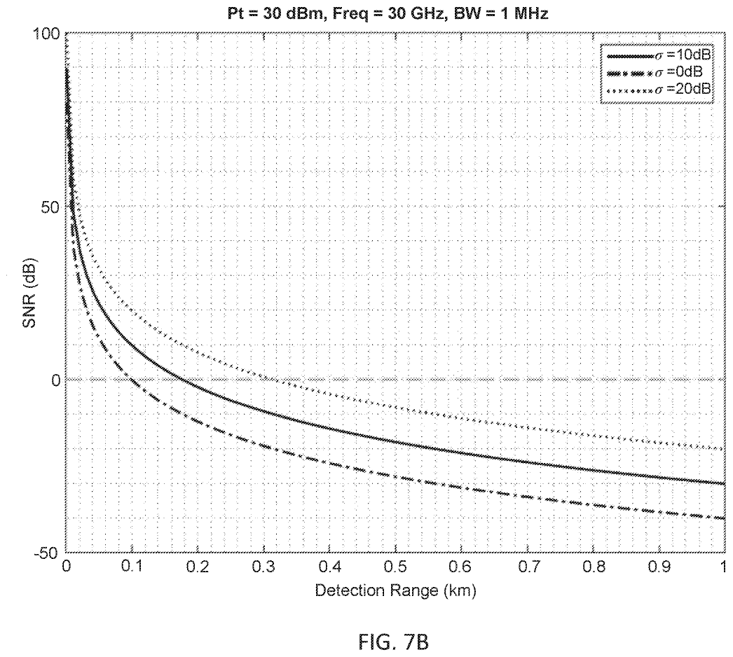

FIG. 7A illustrates an exemplary diagram of a communication link between base station antennas and IRS-UE, in accordance with some embodiments of the present disclosure. In some embodiments, a BS 702 comprises a plurality of antennas 706-1 to 706-n, which may be arranged in an antenna array and be in communication with a UE coupled to an IRS 714, wherein the IRS 714 comprises a plurality of reconfigurable reflecting elements 732-1 to 732-n. In one embodiment, the plurality of antennas 706-1 to 706-n may be in communication with a plurality of sensors 734-1 to 734-m in the IRS 714 to form a MIMO system. For example, a MIMO channel can be formed between the i-th antenna element in the plurality of antennas 706-1 to 706-n with i=1, . . . , n and the j-th sensor element of the plurality of sensors 734-1 to 734-m with j=1, . . . , m. In some embodiments, the communication channel from the BS 702 to the IRS 714 may be represented by a channel matrix h∈ [symbol] . Similarly, the communication channel from the IRS 714 and to BS 702 may be represented by a channel matrix g∈ [symbol] .

In some embodiments, the pathlosses from the BS 702 to the IRS 714 and from the IRS 714 to the BS 702 may be represented by PL₁ and PL₂, respectively. The propagation delays from the BS 702 to the IRS 714 and from the IRS 714 to the BS 702 may be represented by τ₁ and τ₂, respectively. In some embodiments, the BS 702 transmits each pulse at a transmit power P_{T}, and the BS 702 has a first transmission power gain G_{BS,TX} and a first receive power gain G_{BS,RX}. On the UE side, the IRS 714 reflects signals at a receive power P_{R}. In some embodiments, the IRS 714 has a second transmission power gain (e.g. the total reflector's gain) that can be represented by G_{IRS}, wherein G_{IRS} may be a function of the number of reconfigurable reflecting elements in the IRS 714, the size of each reconfigurable reflecting element, and the operating frequency of the received signals.

In some embodiments, the IRS 714 is configured to reflect reference signals transmitted from the BS 702, wherein the BS 702 receives a delayed-Doppler shifted version of the transmitted reference signals. The propagation delay and the Doppler shift depend on the distance and the velocity of the target UE, respectively. In some embodiments, both the propagation delay and the Doppler shift are considered in the receiver design of the BS 702. In some other embodiments, the delay and the Doppler shift are not considered in the receiver design of the BS 702, and the BS 702 receives reflected reference signals from the IRS 714, wherein the reflected reference signals are expressed as r=g(hsₚ)+n, wherein r denotes the reflected reference signals received at the BS 702, g and h denote the communication channel matrix from the IRS 714 to the BS 702 and the communication channel matrix from the BS 702 to the IRS 714, respectively, s_{b} denotes the reference signals transmitted from the BS 702 to the IRS 714, and n denotes a complex Gaussian noise [symbol] (0, N₀Iₙ), wherein Iₙ is the identify matrix of size n×n and N₀ is a scalar parameter used to scale the covariance matrix of the complex Gaussian noise. In some embodiments, the communication channel from the IRS 714 and to BS 702 and the communication channel from the BS 702 to the IRS 714 have reciprocity. Therefore, g=h^{T} wherein T denotes the transpose operation of a matrix. As a result, the received signal at the BS 702 may be expressed as r=h^{T}(hs_{b})+n, wherein the received channel matrix h^{T}h is used for channel estimation.

In some embodiments, the reciprocity between the two channels from the BS 702 to the IRS 714 and from the IRS 714 to the BS 702 results in PL₁=PL₂=PL. In such a case, the receive power P_{R} of each reflected reference signal pulse at the BS 702 may be expressed as: P_{R}=P_{T}+G_{BS,TX}−2PL+G_{IRS}+G_{BS,RX}. Accordingly, the reference signal transmit power P_{T} at the BS 702, the G_{BS,TX} and G_{BS,RX} antenna gains during BS transmission and reception, respectively, and the total reflector's gain G_{IRS} must be sufficient to compensate for the pathloss 2PL mentioned above such that the received reflected signal's strength is strong enough for the channel estimation signal processing. In some embodiments, G_{BS}=G_{BS,TX}+G_{BS,RX} represents a total BS antenna gain when transmitting a reference signal and when receiving the reflection. An exemplary advantage of processing reflections at the BS is that the sum gain at the BS (GBs) allows for efficient and practical design of the IRS (e.g., a relatively low number of elements at the frequency of operation can be employed).

In some embodiments, the IRS 714 comprising the plurality of reconfigurable reflecting elements 732-1 to 732-n may be configured to work in one of the two following modes: Mode 1, wherein the IRS 714 is configured as a single beamformer whereby all the elements from the plurality of reconfigurable reflecting elements 732-1 to 732-n adjust their gain/phase shifts to steer the incident wave in a single direction. Mode 2, wherein the IRS 714 is configured as a plurality of antennas, wherein each of the plurality of antennas comprises a subgroup of reconfigurable elements in the IRS 714. For example, the plurality of reconfigurable reflecting elements 732-1 to 732-n with n reconfigurable reflecting elements in the IRS 714 may be partitioned into k antennas, wherein each of the k antennas comprises n/k reconfigurable reflecting elements. In one embodiment, Mode 1 can be considered as a special case of Mode 2 where the number of antennas is set to one.

In some embodiments, as discussed above, when channel reciprocity exists, both the DL and UL channels can be estimated using uplink SRSs transmitted by the UEs to the BSs. One limitation of this approach is that the number of SRS resources is limited, and SRS resources are typically reused in adjacent cells and sometimes even in the same cell. This leads to an interference problem for which some mitigation solutions are investigated. The method of channel estimation disclosed herein relieves this problem since RS resources from the network are relatively more plentiful than SRS resources from the UE side, which could lead to less reuse of SRS resources and hence reduced interference.

FIG. 7B illustrates an example of detection range enhancement by IRS gain, in accordance with some embodiments of the present disclosure. The detection range of a wireless communication device (e.g. an IRS) may be referred to as the maximum distance over which a signal transmitted by the wireless communication device can be reliably received by a receiver. The x-axis of FIG. 7B represents the detection range and the y-axis represents the signal-to-noise ratio (SNR) of a transmitted signal. In some embodiments, the gain of an IRS can help increase the detection range for a transmission frequency of 30 GHz along with an RS bandwidth of 1 MHz. As can be observed in FIG. 7B, for the IRS gains of 0, 10 and 20 dB, the detection range can be increased from about 100 meters to 180 meters and 300 meters, respectively, to meet SNR criterion of 0 dB. The improved detection allows fewer resources required to transmit the RSs. This is essential in cellular networks since boosting the transmit power is not acceptable as it increases the inter-cell interference.

In some embodiments, to provide strong enough reflection(s) that can be reliably detected by the BS, the following relationship must be satisfied: P_{T}+G_{BS,Tx}−PL₁+G_{IRS}−PL₂+G_{BS,Rx}≥R_{BS,sensitivity} (dBm), where P_{T} is the BS transmit power (dBm), G_{BS,Tx} and G_{BS,Rx} in dB are the BS transmit and receive antenna gains, respectively, G_{IRS} is the IRS gain in dB, PL₁ and PL₂ are the BS to UE and UE to BS path losses (dB), respectively, and R_{BS,sensitivity} is the BS minimum sensitivity level (dBm) to detect the reflections reliably. A numerical example using typical parameters in 5G NR is given below to illustrate the feasibility of this concept:

Due to the channel reciprocity consider PL₁=PL₂=100 dB and a RS signal bandwidth 1 MHz. Furthermore, assume that the BS minimum sensitivity level is at SNR=3 dB above the noise level. This yields:

$${R}_{BS , sensitivity} = - 174 \frac{dB m}{Hz} + 10 log ( 1 {0}^{6} Hz ) + 3 = - 1 \; 11 dBm ,$$

where the value −174 is the thermal noise floor computed at dBm per Hz. Further consider the BS transmit power P_{T} to be 1 Watt (30 dBm). Applying the inequality above yields:

$${G}_{B S , Tx} + {G}_{IRS} + {G}_{BS , Rx} \geq ( - 111 + 200 - 30 ) dB = 59 dB$$

The above inequality can be achieved with a BS having an antenna gain of 25 dB and an IRS having an antenna gain of 9 dB, which is quite feasible, especially at the upper range of frequencies used by NR (i.e., 30 GHz and above mmWave bands) with an IRS having a sufficiently large number of elements.

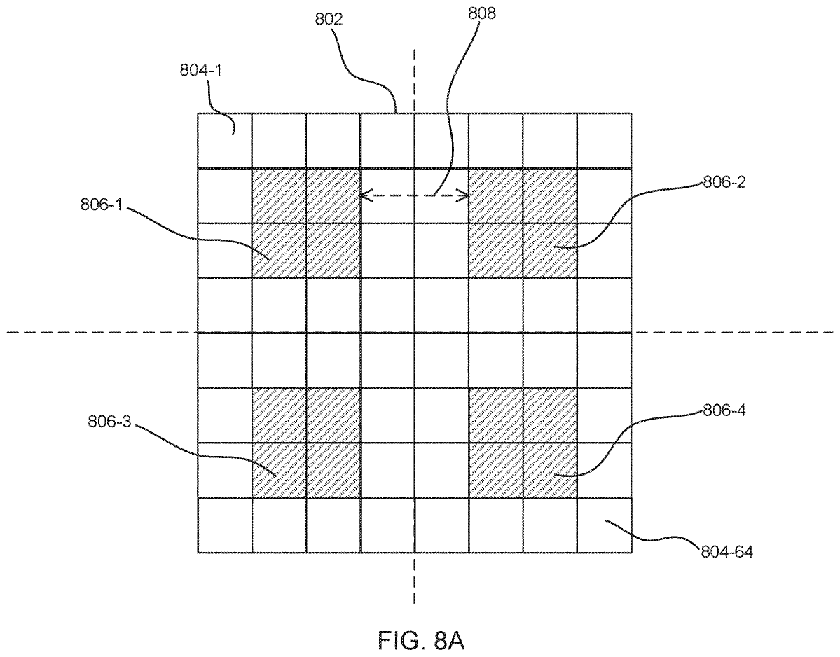

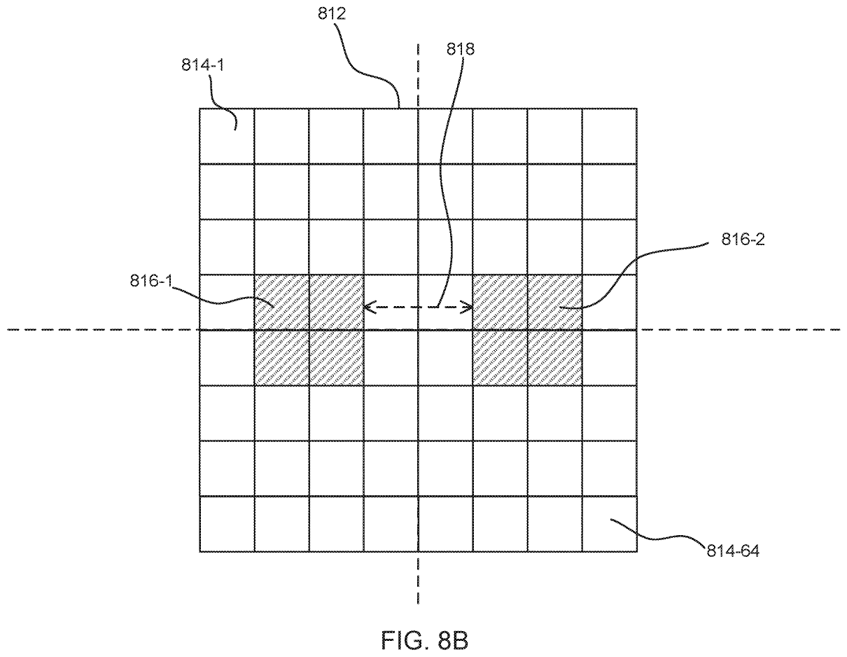

FIGS. 8A and 8B illustrate two exemplary IRS antenna group configurations, in accordance with some embodiments of the present disclosure. As shown in FIG. 8A, in some embodiments, an IRS 802 comprising a total of 64 reconfigurable reflecting elements 804-1 to 804-64 may be partitioned into 4 antennas 806-1 to 806-4, with n=64 and k=4. In some other embodiments, as shown in FIG. 8B, an IRS 812 comprising a total of 64 reconfigurable reflecting elements 814-1 to 814-64 may be partitioned into 2 antennas 816-1 and 816-2, with n=64 and k=2. In still some other embodiments, an IRS comprising a total of 1024 reconfigurable reflecting elements may be partitioned into 2 antennas, each of which comprises 512 reconfigurable reflecting elements with n=1024 and k=2. In yet some other embodiments, an IRS comprising a total of 1024 reconfigurable reflecting elements may be partitioned into 4 antennas, each of which comprises 256 reconfigurable reflecting elements with n=1024 and k=4. In this way, it may be possible to increase the transmission rank to and from the UE coupled to the IRS beyond that of a single beam. The transmission rank may be referred to as the quality of connection between the UE and a corresponding BS. In some embodiments, the IRS comprises k antennas, and the IRS may be configured to provide k RS reflections to the transmitting BS, wherein each of the k reflections corresponds to a respective one of the k configured antennas in the IRS.

Referring to FIG. 8A, in some embodiments, all the reconfigurable reflecting elements in each of the 4 antennas are assigned/used as a group of resources elements (REs) assigned for each UE enabled for incident signal reflections. In some other embodiments, only a portion of the reconfigurable reflecting elements in each of the 4 antennas is enabled for incident signal reflections, as shown by the reconfigurable reflecting elements with upward diagonal pattern fills in each of the 4 antennas. The subgroup of enabled reconfigurable reflecting elements in each antenna may be referred to as an “active reconfigurable reflecting element group” in the antenna. In some embodiments, a portion of the reconfigurable reflecting elements in each of the 4 antennas is enabled such that adjacent active reconfigurable reflecting element groups are separated by a minimum distance, as will be discussed in detail below. For example, the antenna 806-1 comprises an active reconfigurable reflecting element group of 4 reconfigurable reflecting elements, as shown by the 4 reconfigurable reflecting elements with upward diagonal pattern fills in the antenna 806-1 of FIG. 8A. In some embodiments, the number of reconfigurable reflecting element groups and the number of reconfigurable reflecting elements in each group are configurable during signal transmission between the IRS 714 and the BS 702.

In some embodiments, in Mode 1 of the IRS configuration described above, the IRS comprising n reconfigurable reflecting elements is configured to function as a single beamformer, wherein the phase shifts of all the n reconfigurable reflecting elements are adjusted to focus the reflection as a narrow beam towards the transmitting BS, with a gain (in dB) proportional to 10 log(n). In some other embodiments, in Mode 2 of the IRS configuration described above, the IRS comprising n reconfigurable reflecting elements is configured to function as multiple antennas, wherein the IRS is partitioned into k antennas, each having (n/k) reconfigurable reflecting elements. In this case, the IRS creates k beams using all the (n/k) reconfigurable reflecting elements of each of the k antennas to create generally wider beams with gain (in dB) proportional to 10 log(n/k). In some embodiments, each of the k antennas into which the IRS is partitioned is separated from adjacent antennas by a distance d. In some other embodiments, the active reconfigurable reflecting element group in each antenna is separated from adjacent active reconfigurable reflecting element groups in other antennas by a distance d, as shown by the distances 808 and 818 in FIGS. 8A and 8B, respectively. In some embodiments, the distances 808 and 818 for separating adjacent active reconfigurable reflecting element groups are determined as d=α(λ/2), where λ is the wavelength of the signals transmitted between the IRS and the BS, and the scaling factor α≥1 to ensure transmissions from each of the k antennas have low correlations. By setting α≥1, the adjacent active reconfigurable reflecting element groups in different antennas are spaced at least half a wavelength apart. In this way, mutual coupling and interference between adjacent antennas can be reduced. In some embodiments, the value of a is determined based on various factors such as the specific application, desired performance metrics, and the characteristics of the electromagnetic environment. In Mode 2 of the IRS configuration described above, the IRS can provide spatial diversity with enhanced rank transmission (i.e. transmission rank≥1).

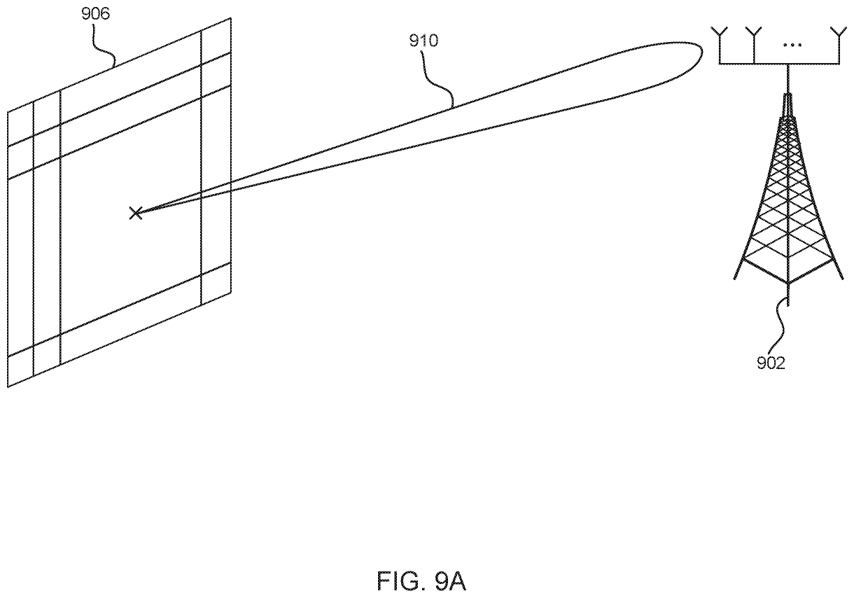

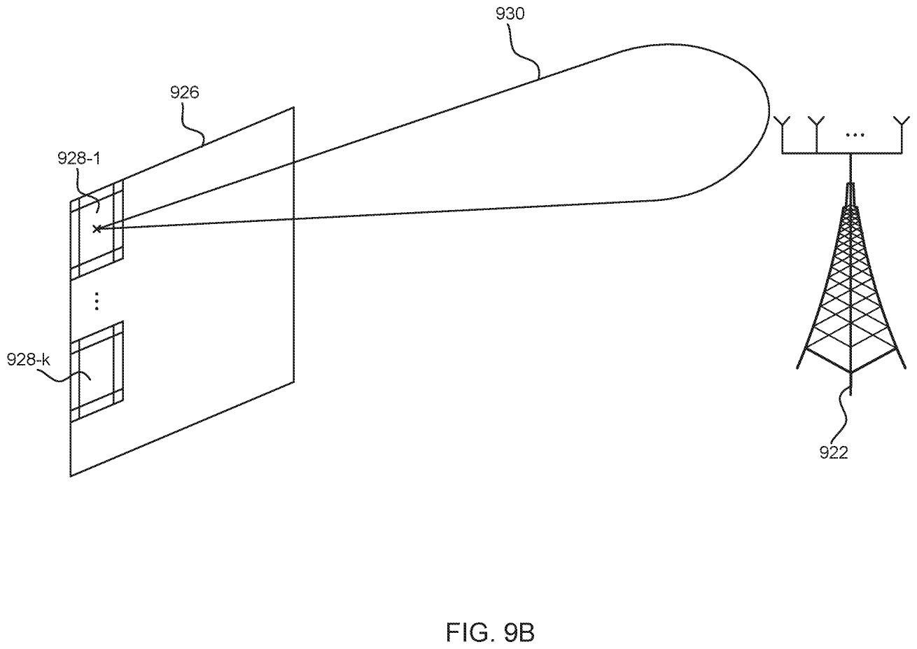

FIG. 9A illustrates an exemplary wireless communication diagram with IRS configured as a single antenna, in accordance with some embodiments of the present disclosure. In some embodiments, an IRS 906 coupled to a UE may be in communication with a BS 902, wherein the IRS 906 is configured to operate in Mode 1 described above, wherein the IRS 902 is configured as a single beamformer whereby all the reconfigurable reflecting elements in IRS 902 adjust their gain/phase shifts to steer the incident wave in a single direction, as shown by the reflected signal 910 in FIG. 9A. In some embodiments, the reflected signal 910 generated by the IRS 916 is a narrow beam with a gain proportional to 10 log(n) dB, wherein is n the number of reconfigurable reflecting elements in IRS 902.

FIG. 9B illustrates another exemplary wireless communication diagram with IRS configured as multiple antennas, in accordance with some embodiments of the present. disclosure. In some embodiments, an IRS 926 coupled to a UE may be in communication with a BS 922, wherein the IRS 926 is configured to operate in Mode 2 described above, wherein the IRS 926 is configured as a plurality of antennas 928-1 to 928-k, wherein each of the plurality of antennas 928-1 to 928-k comprises a subgroup of reconfigurable elements. In some embodiments, the IRS 926 comprises a total number of n reconfigurable elements, which are partitioned into k antennas 928-1 to 928-k, wherein each of the k antennas 928-1 to 928-k comprises n/k reconfigurable elements. In some embodiments, each of the k antennas 928-1 to 928-k generates a respective wider beam compared to the beam generated by the single beamformer IRS 906 shown in FIG. 9A. For example, the signal 930 generated by the antenna 928-1 may be a beam that is wider than the beam of signal 910 generated by the single beamformer IRS 906 shown in FIG. 9A. In some embodiments, each of the k antennas 928-1 to 928-k generates a wider beam with a gain proportional to 10 log(n/k) dB using all the n/k reconfigurable elements. In some other embodiments, IRS 926 generates k beams from the k antennas 928-1 to 928-k using fewer than n/k reconfigurable elements in each of the k antennas 928-1 to 928-k to create wider beams.

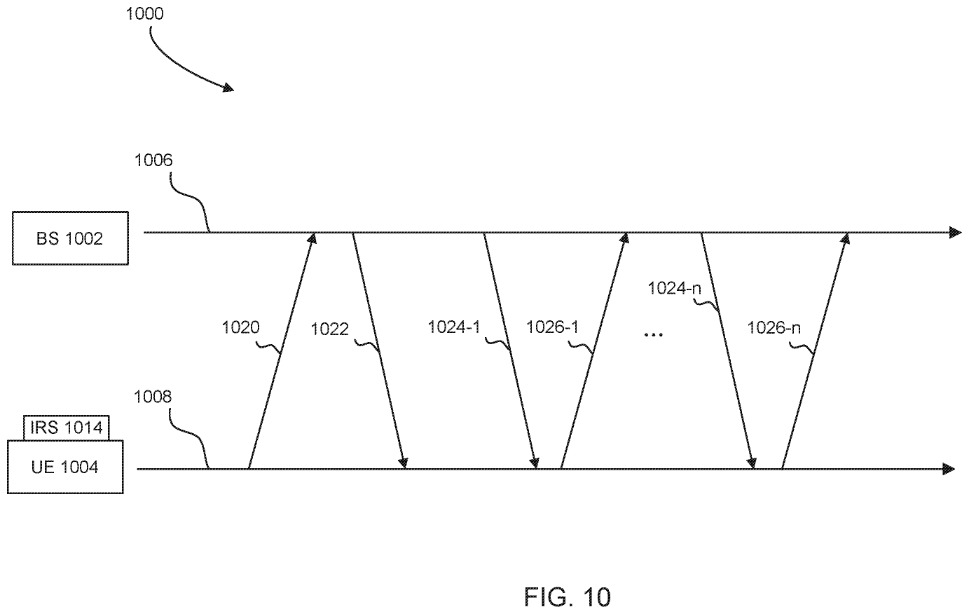

FIG. 10 illustrates an exemplary signaling diagram 1000 for IRS installed UE channel estimation, in accordance with some embodiments of the present disclosure. In some embodiments, a UE 1004 coupled to an IRS 1014 may be configured to transmit a first signal 1020 along a time axis 1008 to a BS 1002. In some embodiments, the first signal 1020 comprises a capability message, wherein the capability message comprises in indication to indicate that the IRS 1014 coupled to the UE 1004 comprises a total number of n reconfigurable elements, and that the IRS 1014 can support for a maximum number of kₘₐₓ antennas (or antenna ports) at the UE 1004. Upon receiving the first signal 1020, the BS 1002 may be configured to transmit a second signal 1022 along a time axis 1006 back to the UE 1004. In some embodiments, the second signal 1022 comprises a configuration message to indicate a plurality of parameters comprising k, nₛ, nᵣ, n_{f} and nₚ, wherein k, nₛ, nᵣ, n_{f} and nₚ denote number of required antennas, symbol separation, pattern repetition, frequency spacing in subcarriers, and periodicity in symbols, respectively. In some embodiments, the number of antennas k indicated by the second signal 1022 is set as k≤kₘₐₓ.

Upon receiving the second signal 1022, the UE 1004 coupled to the IRS 1014 may prepare to receive data transmission by configuring the IRS 1014 based on the indicated plurality of parameters in the second signal 1022. After transmitting the second signal 1022, the BS 1002 may be configured to transmit one or more third signals 1024-1 to 1024-n to the UE 1004 coupled to the IRS 1014. In some embodiments, the one or more third signals 1024-1 to 1024-n comprise RS signals transmitted by the BS 1002. Upon receiving the one or more third signals 1024-1 to 1024-n, the UE 1004 coupled to the IRS 1014 may be configured to reflect each of the one or more third signals 1024-1 to 1024-n to generate one or more fourth signals 1026-1 to 1026-n back towards the BS 1002. In some embodiments, the one or more fourth signals 1026-1 to 1026-n may be used to perform a channel estimation between the UE 1004 and the BS 1002.

In some embodiments, the configuration message in the second signal 1022 transmitted by the BS 1002 comprises an indication to indicate whether the IRS 1014 operates as a Mode 1 single beam reflector with rank=1, or as a Mode 2 multiple-antenna beam reflector with rank≥1. Then based on the received configuration message in the second signal 1022, the IRS 1014 may be configured to operate as a single beam reflector or as a multiple-antenna beam reflector. In some embodiments, whether the IRS 1014 is configured to operate as a single beam reflector or as a multiple-antenna beam reflector is derived from: 1) the total number n of the reconfigurable elements in the IRS 1014, and 2) the total number k of antennas in the IRS 1014. In some embodiments, the UE 1004 uses the total number n of the reconfigurable elements in the IRS 1014 and the total number k of antennas in the IRS 1014 to determine whether the IRS 1014 is configured to operate as a single beam reflector or as a multiple-antenna beam reflector.

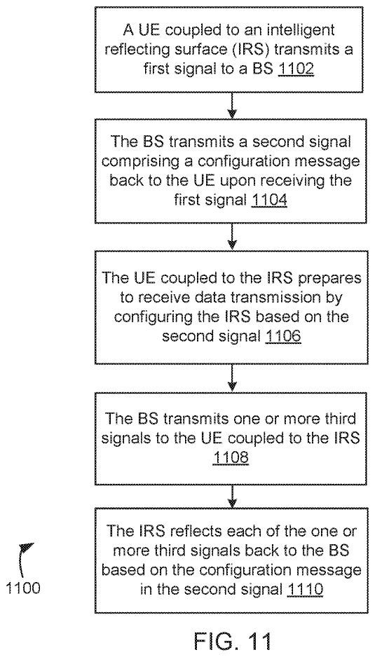

FIG. 11 illustrates an example method 1100 for performing IRS installed UE channel estimation, in accordance with some embodiments. The operations of method 1100 presented below are intended to be illustrative. In some embodiments, method 1100 may be accomplished with one or more additional operations not described and/or without one or more of the operations discussed. Additionally, the order in which the operations of method 1100 are illustrated in FIG. 11 and described below is not intended to be limiting.

At step 1102, a UE coupled to an IRS transmits a first signal to a BS. In some embodiments, the first signal comprises a capability message, wherein the capability message comprises in indication to indicate that the IRS comprises a total number of n reconfigurable elements, and that the IRS can support for a maximum number of kₘₐₓ antennas at the UE.

At step 1104, upon receiving the first signal, the BS may be configured to transmit a second signal back to the UE. In some embodiments, the second signal comprises a configuration message to indicate at least one of a plurality of parameters comprising k, nₛ, nᵣ, n_{f} and nₚ, wherein k, nₛ, nᵣ, n_{f} and nₚ denote the number of required antennas, the symbol separation, the pattern repetition, the frequency spacing in subcarriers, and the periodicity in symbols, respectively. In some embodiments, the number of antennas k indicated by the second signal is set to be k≤kₘₐₓ. In some other embodiments, the configuration message in the second signal comprises an indication to indicate whether the IRS operates as a Mode 1 single beam reflector with rank=1, or as a Mode 2 multiple-antenna beam reflector with rank≥1.

At step 1106, upon receiving the second signal, the UE coupled to the IRS may prepare to receive data transmission by configuring the IRS based on the indicated plurality of parameters in the second signal.

At step 1108, the BS may be configured to transmit one or more third signals to the UE coupled to the IRS. In some embodiments, the one or more third signals comprise reference signals transmitted by the BS.

At step 1110, upon receiving the one or more third signals, the IRS may be configured to reflect each of the one or more third signals back towards the BS. In some embodiments, based on the received configuration message from the second signal, the IRS may be configured to operate as a single beam reflector or as a multiple-antenna beam reflector. In some embodiments, whether the IRS is configured to operate as a single beam reflector or as a multiple-antenna beam reflector is derived from: 1) the total number n of the reconfigurable elements in the IRS, and 2) the total configured number k of antennas in the IRS. In some embodiments, the UE uses the total number n of the reconfigurable elements in the IRS and the total number k of antennas in the IRS to determine whether the IRS is configured to operate as a single beam reflector or as a multiple-antenna beam reflector.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques.

To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, module, etc. can be configured to perform one or more of the functions described herein. The term “configured to” or “configured for” as used herein with respect to a specified operation or function refers to a processor, device, component, circuit, structure, machine, module, etc. that is physically constructed, programmed and/or arranged to perform the specified operation or function.

Furthermore, a person of ordinary skill in the art would understand that various illustrative logical blocks, modules, devices, components and functions described herein can be implemented within or performed by one or more circuits or circuitry. As used herein, the term “circuitry” refers to and includes any one or more of the following: discrete circuit components or devices coupled to each other to form circuit, logic circuitry, integrated circuits, application specific integrated circuits, state machines, general purpose processors, special purpose processors, digital signal processors (DSP), microprocessors, field programmable gate arrays (FPGA) or other programmable logic devices, or any combination thereof. Circuitry can further include antennas, reflectors, transmitters, receivers and/or transceivers to communicate with various components, devices or nodes within a communication network. As used herein, the term “processor” refers to a combination of structures including processing circuitry, a memory coupled to the processing circuitry, and executable code stored in the memory that when executed by the processing circuitry perform the functions or operations instructed by the executable code.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such non-transitory computer-readable media can include RAM, ROM, EEPROM, CD-ROM or other optical disk storage, magnetic disk storage or other magnetic storage devices, or any other non-transitory medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A method comprising:
transmitting, at a wireless communication device, a first signal to a wireless communication node, wherein the first signal comprises a capability message, wherein the capability message comprises an indication to indicate:
a first number of a plurality of reconfigurable elements in an Intelligent Reflecting Surface (IRS) coupled to the wireless communication device, and
a second number of at least one antenna that can be supported by the IRS, wherein each of the at least one antenna comprises at least one of the plurality of reconfigurable elements; and
receiving, at the wireless communication device, a second signal from the wireless communication node, wherein the second signal comprises a configuration message, wherein the configuration message comprises a plurality of parameters to be configured in the IRS.

2. The method of claim 1, further comprising:
receiving, at the wireless communication device, one or more third signals from the wireless communication node, wherein the one or more third signals comprises one or more reference signals transmitted by the wireless communication node; and
reflecting, at the wireless communication device, each of the one or more third signals to generate a respective one of one or more fourth signals using the IRS based on the configuration message in the second signal, wherein the one or more fourth signals are used to perform a channel estimation between the wireless communication device and the wireless communication node.

3. The method of claim 1, further comprising:
configuring, at the wireless communication device, the IRS based on the plurality of parameters in the configuration message.

4. The method of claim 3, wherein the plurality of parameters comprises at least one of:
a third number of required antennas in the IRS, wherein the third number is less than or equal to the second number;
a symbol separation;
a pattern repetition;
a subcarrier frequency spacing; and
a symbol periodicity.

5. The method of claim 1, wherein the configuration message further comprises an indication to indicate whether:
the IRS operates as a single beam reflector, wherein a respective phase shift of each of the plurality of reconfigurable elements is adjusted such that reflections generated by the IRS are focused to one first beam, or
the IRS operates as a multiple-antenna beam reflector, wherein the third number is greater than 1, and each of the third number of required antennas is configured to generate a respective second beam.

6. The method of claim 5, wherein the respective second beam associated with each of the third number of required antennas is wider than the first beam.

7. The method of claim 1, wherein each of the at least one antenna is separated from adjacent antennas by a respective distance, wherein the respective distance is determined by a wavelength of signals transmitted between the IRS and the wireless communication node.

8. A wireless communication device comprising:
a transceiver configured to:
transmit a first signal to a wireless communication node, wherein the first signal comprises a capability message, wherein the capability message comprises in indication to indicate:
a first number of a plurality of reconfigurable elements in an Intelligent Reflecting Surface (IRS) coupled to the wireless communication device, and
a second number of at least one antenna that can be supported by the IRS, wherein each of the at least one antenna comprises at least one of the plurality of reconfigurable elements; and
receive a second signal from the wireless communication node, wherein the second signal comprises a configuration message, wherein the configuration message comprises a plurality of parameters to be configured in the IRS.

9. A non-transitory computer readable medium storing computer-executable instructions which when executed cause the wireless communication device to perform the method of claim 1.

10. Circuitry configured to cause the wireless communication device to perform the method of claim 1.

11. A method comprising:
receiving, at a wireless communication node, a first signal from a wireless communication device, wherein the first signal comprises a capability message, wherein the capability message comprises in indication to indicate:
a first number of a plurality of reconfigurable elements in an Intelligent Reflecting Surface (IRS) coupled to the wireless communication device, and
a second number of at least one antenna that can be supported by the IRS, wherein each of the at least one antenna comprises at least one of the plurality of reconfigurable elements; and
transmitting, at the wireless communication node, a second signal to the wireless communication device, wherein the second signal comprises a configuration message, wherein the configuration message comprises a plurality of parameters to be configured in the IRS.

12. The method of claim 11, further comprising:
transmitting, at the wireless communication node, one or more third signals to the wireless communication device, wherein the one or more third signals comprises one or more reference signals; and
receiving, at the wireless communication node, one or more fourth signals, wherein each of the one or more fourth signals is generated by the IRS by reflecting a respective one of the one or more third signals based on the configuration message in the second signal, wherein the one or more fourth signals are used to perform a channel estimation between the wireless communication device and the wireless communication node.

13. The method of claim 11, wherein the plurality of parameters comprises at least one of:
a third number of required antennas in the IRS, wherein the third number is less than or equal to the second number;
a symbol separation;
a pattern repetition;
a subcarrier frequency spacing; and
a symbol periodicity.

14. The method of claim 13, wherein the configuration message further comprises an indication to indicate whether:
the IRS operates as a single beam reflector, wherein a respective phase shift of each of the plurality of reconfigurable elements is adjusted such that reflections generated by the IRS are focused to one first beam, or
the IRS operates as a multiple-antenna beam reflector, wherein the third number is greater than 1, and each of the third number of required antennas is configured to generate a respective second beam.

15. The method of claim 14, wherein the respective second beam associated with each of the third number of required antennas is wider than the first beam.

16. The method of claim 14, wherein:
the one first beam is associated with a first gain; and
the respective second beam is associated with a respective second gain, wherein the first gain is larger than the respective second gain.

17. (canceled)

18. A non-transitory computer readable medium storing computer-executable instructions which when executed cause the wireless communication node to perform the method of claim 11.

19. Circuitry configured to cause the wireless communication node to perform the method of claim 11.

20. (canceled)
